(19) United States
(12) Patent Application Publication
(10) Pub. No.: US 2012/0192723 A1
(43) Pub. Date: Aug. 2, 2012

(54) SHISH KEBOB ROTISSERIE DEVICE

(76) Inventor: Bogdan Pototsky, Camillus, NY (US)

(21) Appl. No.: 13/019,501

(22) Filed: Feb. 2, 2011

(51) Int. Cl. A47J 37/04

(52) U.S. Cl. 99/421 V

(57) ABSTRACT

A kabob rotisserie for cooking multiple kabobs comprising: a top plate, where the top plate includes a plurality of holding nests and each nest receives a kabob skewer; a bottom plate, where the bottom plate includes a plurality of holding nests and each nest receives a kabob skewer; a rotating shaft, vertically extending through the top plate and bottom plate; a heating element attached to the rotating shaft, where the element is positioned inside the kabob skewers; bearings provided at the top and bottom of the rotating shaft; a cover, where the cover contains the kabob rotisserie; and a motor, where the motor rotates the rotating shaft. In one exemplary embodiment, the top plate may include eight or less holding nests and the bottom plate may include eight or less corresponding holding nests.

### BACKGROUND OF THE INVENTION

1. Field of Invention

The present invention relates to a shish kebob rotisserie device that enables the rotisserie grilling of multiple shish kebobs.

2. Description of Related Art

Rotisserie grilling is a popular style of roasting meat, where meat is placed upon a skewer and rotated on a rod where heat radiated over the surface of the meat. As the meat rotates, it provides an even distribution of the heat that is applied over the surface of the meat as it is rotated. The advantage of rotisserie grilling is that the meat cooks evenly and allows for a juicy basting of the meat within its own juices. Excess fat is readily drained or dripped from the meat itself and normally allowed to deposit in a pan that is typically placed under the meat as it rotates through the rotisserie. Rotisserie grillers and cookers are used on all types of meat (pork, turkey, beef, chicken) and the rotisserie may rotate the meat either horizontally or vertically depending upon design.

A shish kebab is a popular dish where pieces of meat are placed upon a skewer and grilled on a grill. The shish kebab may be also baked or roasted and therefore served in pans. Most kebabs are placed upon a grill for cooking, although some rotisserie devices have been developed for kebabs.

### SUMMARY OF THE INVENTION

The present invention relates to a kabob rotisserie for cooking multiple kabobs comprising: a top plate, where the top plate includes a plurality of holding nests and each nest receives a kabob skewer; a bottom plate, where the bottom plate includes a plurality of holding nests and each nest receives a kabob skewer; a rotating shaft, vertically extending through the top plate and bottom plate; a heating element attached to the rotating shaft, where the element is positioned inside the kabob skewers; bearings provided at the top and bottom of the rotating shaft; a cover, where the cover contains the kabob rotisserie; and a motor, where the motor rotates the rotating shaft. In one exemplary embodiment, the top plate may include eight or less holding nests and the bottom plate may include eight or less corresponding holding nests. The cover may include a rotating shaft that engages the rotating shaft of the kabob rotisserie. Further, an oil pan may be placed below the kabob assembly.

### BRIEF DESCRIPTION OF DRAWINGS

FIG. 1 depicts a sectional view of a kabob rotisserie according to the present invention.

FIG. 2 depicts a sectional view of the internal components of the kabob rotisserie according to the present invention.

FIG. 3 depicts holding plates, which secure the kabobs that are used in the kabob rotisserie according to the present invention.

### DETAILED DESCRIPTION

The present invention relates to a kabob rotisserie device that is utilized to easily grill in a rotisserie fashion multiple shish kabobs in an efficient and easy manner. The present invention includes rotating plates that engage multiple shish kabobs in a vertical position and rotate these shish kabobs around a heating element while being enclosed with a cover. This method of grilling ensures that the kabobs are cooked evenly and remain tender and juicy. Further excessive fat or oils that may release from the cooked meat is allowed to drip to a pan that is placed under the rotating kabobs. The rotating plates allows for a quick cooking process of multiple shish kabobs in a single period of time. Such a device would be advantageous both in a home or restaurant environment.

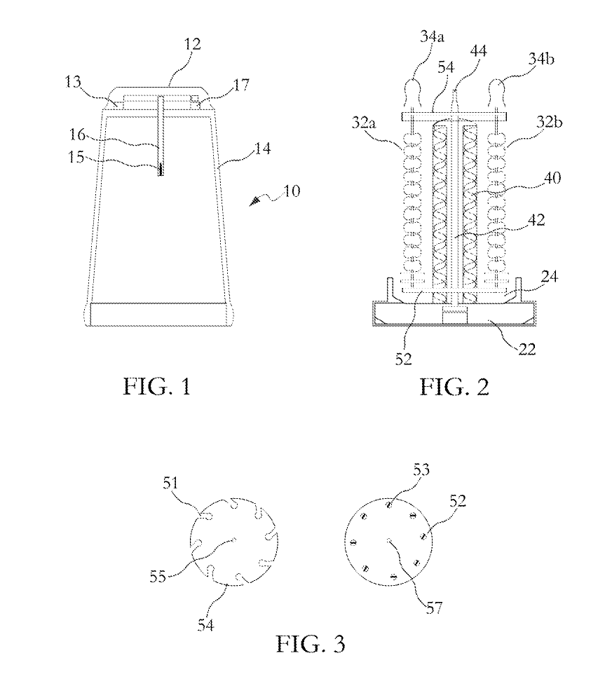

In reference to FIG. 1, a sectional view of a kabob rotisserie 10 is displayed according to the present invention. This cross-sectional view depicts a cover or Cap 12 that is placed over rotating shish kabobs that are more clearly displayed in FIG. 2. The Cover 12 includes a

Power Converter 13 and an AC Motor 17 that provide for the rotation of the Driveshaft 16. The Driveshaft 16 includes a Shaft Insert Hole 15 that receives the rotating shaft that moves the plates that hold the multiple kabobs in place. The Cap or Cover 12 may include a clear plastic panel so that a user can observe the cooking process and ensure that the kabobs are being cooked in a proper manner.

FIG. 2 depicts a sectional view of a kabob assembly where the kabobs are placed within the Cap 12 for cooking. These internal components are the essential elements that provide for the cooking of the multiple kabobs. As depicted an Upper Plate 54 and a Lower Plate 52 provide the means to support the kabobs in a vertical position as the kabobs rotate around the Heating Element 40. A Rotating Shaft 42 extends vertically between the Lower Plate 52 and Upper Plate 54 and rotates upon the Bottom Bearing 22. The top of a Rotating Shaft 42 includes a Shaft Connector 44 that engages into the Shaft Insert Hole 15 as shown in FIG. 1. Multiple kabobs may be engaged between the Lower Plate 52 and Upper Plate 54 and rotate in a circular motion around the Heating Element 40. In FIG. 2, two Kabobs 32a, 32b are depicted. These Kabobs 32a, 32b include Handles 34a, 34b respectively. Although two kabobs are shown in FIG. 2, as can be seen in FIG. 3 up to eight kabobs may be placed between the Upper Plate 54 and Lower Plate 52. An Oil Pan 24 is provided beneath the rotating plates to contain any oils and fats that may drip from the kabobs during the cooking process.

FIG. 3 depicts a view of the Upper Plate 54 and Lower Plate 52. As noted the Upper Plate 54 includes a plurality of Holding Nests 51 that receive the kabob rods. The Holding Nests 51 are positioned around the perimeter of the Upper Plate 54 which also includes a Center Opening 55. The Center Opening 55 allows for the insertion of the Rotating Shaft 42 shown in FIG. 2. Further in FIG. 3, the Lower Plate 52 is depicted which includes Holding Nests 53 that are located around the perimeter of the Lower Plate 52. The Holding Nests 53 receive one end of each kabob, in particular the end opposite the handles as shown in FIG. 2. The Lower Plate 52 also includes a Center Opening 57 therefore once the complete rotisserie is assembled up to eight kabobs may be placed into the respective holding nets of the Upper Plate 54 and Lower Plate 52 and then inserted into the kabob rotisserie tin. Once inserted into the holding nests the Cover 12 is placed over this device and the heating process is initiated through the use of the power converter and Motor 17.

The kabob rotisserie according to the present invention provides an effective means to cook multiple kabobs in a motor-operated rotisserie utilizing rotating skewer rods with rotating holding plates. The Heating Element 40 remains stationary at the center of the rotisserie and therefore enables for an even distribution of heat onto multiple kabob skewers that may be inserted into the kabob rotisserie according to the present invention. Additional features to this kabob rotisserie may include a self-cleaning option to eliminate excessive grease or oil buildup and double-walled protection associated with the Cover 12 as depicted in FIG. 1.

What is claimed is:

1. A kabob rotisserie for cooking multiple kabobs comprising:
a. a top plate, where the top plate includes a plurality of holding nests and each nest receives a kabob skewer;
b. a bottom plate, where the bottom plate includes a plurality of holding nests and each nest receives a kabob skewer;
c. a rotating shaft, vertically extending through the top plate and bottom plate;
d. a heating element attached to the rotating shaft, where the element is positioned inside the kabob skewers;
e. bearings provided at the top and bottom of the rotating shaft;
f. a cover, where the cover contains the kabob rotisserie; and
g. a motor, where the motor rotates the rotating shaft.

2. The kabob rotisserie according to claim 1, where the top plate includes eight or less holding nests and the bottom plate includes eight or less corresponding holding nests.

3. The kabob rotisserie according to claim 1, where the cover includes a rotating shaft that engages the rotating shaft of the kabob rotisserie.

4. The kabob rotisserie according to claim 1, further including an oil pan below the kabob assembly.

5. The kabob rotisserie according to claim 1, further including a power converter.
